(19) United States
(12) Patent Application Publication
(10) Pub. No.: US 2016/0239275 A1
(43) Pub. Date: Aug. 18, 2016

(54) GENERATING AN INTEGRATED SERVICE

(71) Applicant: HCL Technologies Limited, Noida (IN)

(72) Inventors: Prathameshwar Pratap Singh, Noida (IN); Yogesh Gupta, Noida (IN); Sanjay Kumar, Noida (IN)

(21) Appl. No.: 14/980,741

(22) Filed: Dec. 28, 2015

(30) Foreign Application Priority Data
Jan. 30, 2015 (IN) 281/DEL/2015

(51) Int. Cl. G06F 9/45; H04L 29/08

(52) U.S. Cl. CPC G06F 8/41; H04L 67/02

(57) ABSTRACT

Disclosed is method and system for generating an integrated service. To generate the integrated service, a web service is retrieved using a web browser based on user input. Web service definition of the web service is extracted using web service description language (WSDL) file of the web service. Proxy classes are generated using the web service definition. Proxy classes are compiled to create an assembly file. User enabled to select service method from assembly file, and endpoints for the service method are identified using the web service definition. Service method is converted into custom activity. Workflow file is generated by building a workflow based on predefined activities and the custom activity. The end points are exposed for hosting the workflow file as integrated service. The workflow file is executed, tested and debugged in order to validate the workflow.

### CROSS-REFERENCE TO RELATED APPLICATIONS AND PRIORITY

The present application claims benefit from Indian Complete Patent Application No. 281/DEL/2015, filed on Jan. 30, 2015, the entirety of which is hereby incorporated by reference.

### TECHNICAL FIELD

The present subject matter described herein, in general, relates to generation of integrated services, and more particularly to generation of integrated web based services.

### BACKGROUND

Web services are the web applications interacting with other web applications for sharing data. Web services are primarily used by the businesses as a means for communicating with each other and the clients. Web services share business logic, data and processes through a programmatic interface without providing a user interface. In this ever-changing business world customer requirement related to the web services also change frequently. Further, real world workflows are not constant and change in different dimensions. Existing systems have limitations to map with these varying real world workflows.

Present approach to consume web services comprise developing software applications, building web services based on the software applications or make changes in source code of web services to consume and load data according to required web services. However, present approaches are tedious, costly, time taking, one time exercises and not scalable. Moreover consuming new web services for escalating and changing data requirements is an added overhead in software industries which also affect timelines of software projects. Automated service orchestration tools fail to address current business requirements, upcoming web services, emerging devices and data. No solution available in the art to efficiently map the web services with the varying real world workflows and the emerging devices.

Further, although few solutions talk about providing various types of workflow models and also making dynamic changes to the workflow models, these solutions fail to address duplication of work in generating web services, one time exercises and time consuming nature of generating web services.

### SUMMARY

This summary is provided to introduce aspects related to systems and methods for generating an integrated service and the aspects are further described below in the detailed description. This summary is not intended to identify essential features of the claimed subject matter nor is it intended for use in determining or limiting the scope of the claimed subject matter.

In one implementation, a method for generating an integrated service is described. The method comprises retrieving a web service from a web-service browser, based on an input received from a user. User may provide service URL (Uniform resource locator) for the web service. The method further comprises extracting a web service definition of the web service using a web service description language (WSDL) file associated with the web service, and generating one or more proxy classes using the web service definition in the WSDL file. The method further comprises compiling the one or more proxy classes to create an assembly file. The method further comprises enabling the user to select a service method from the assembly file. The method further comprises identifying one or more endpoints for the service method using the web service definition. The method further comprises converting the service method into a custom activity. The method further comprises generating a workflow file by building a workflow based on one or more predefined activities and the custom activity, and exposing the one or more end points for hosting the workflow file as an integrated service. The retrieving, the extracting, the generating, the compiling, the enabling the user, the identifying, the converting and the exposing the one or more end points is performed by a processor.

In one implementation, a system for generating an integrated service is described. The system comprises a processor and a memory coupled to the processor. The processor is capable of executing programmed instructions stored in the memory to retrieve a web service from a web-service browser based on an input received from a user. The processor further extracts a web service definition of the web service using a web service description language (WSDL) file associated with the web service, and generates one or more proxy classes using the web service definition in the WSDL file. The processor further compiles the one or more proxy classes to create an assembly file. The processor further enables the user to select a service method from the assembly file. The processor further identifies one or more endpoints for the service method, and converts the service method into a custom activity. The processor further generates a workflow file by building a workflow based on one or more predefined activities and the custom activity, and exposes the one or more end points for hosting the workflow file as an integrated service.

In one implementation, a computer program product having embodied thereon a computer program for generating an integrated service is described. The computer program product comprises a program code for retrieving a web service from a web-service browser based on an input received from a user. The computer program product further comprises a program code for extracting a web service definition using a web service description language (WSDL) file associated with the web service. The computer program product further comprises a program code for generating one or more proxy classes using the web service definition in the WSDL file. The computer program product further comprises a program code for compiling the one or more proxy classes to create an assembly file. The computer program product further comprises a program code for enabling the user to select a service method from the assembly file. The computer program product further comprises a program code for identifying one or more endpoints for the service method. The computer program product further comprises a program code for converting the service method into a custom activity. The computer program product further comprises a program code for generating a workflow file by building a workflow based on one or more predefined activities and the custom activity. The computer program product further comprises a program code for exposing the one or more end points for hosting the workflow file as an integrated service.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for generating an integrated service, in accordance with an embodiment of the present subject matter.

FIG. 2 illustrates a user interface of a workflow designer of the system for generating the integrated service, in accordance with an embodiment of the present subject matter.

FIG. 3 illustrates components of the system for generating the integrated service, in accordance with an embodiment of the present subject matter.

FIG. 4 illustrates a flowchart for execution of the integrated service, in accordance with an embodiment of the present subject matter.

FIG. 5 illustrates overall working of system for generating the integrated service, in accordance with an embodiment of the present subject matter.

FIG. 6 illustrates a workflow for generating an integrated service for loan request processing, in accordance with an embodiment of the present subject matter.

FIG. 7 illustrates a method for generating an integrated service, in accordance with an embodiment of the present subject matter.

### DETAILED DESCRIPTION

Systems and methods for generating an integrated service are described. The present subject matter discloses an effective and efficient mechanism for generating the integrated services. The integrated services may be integrated web based services. The integrated web based services may be the web based services generated by integrating functionalities of one or more web services. In order to generate the integrated service, initially one or more web services may be retrieved from a web-service browser, based on an input received from a user. Further, a web service definition of the web service may be extracted using web service description language (WSDL) file associated with the web service. One or more proxy classes may be generated using the web service definition in the WSDL file. Further, the one or more proxy classes may be compiled to create an assembly file. The user may be enabled to select a service method from the assembly file.

Further, one or more endpoints for the service method may be identified and the service method may be converted into a custom activity.

A workflow file may be generated by building a workflow based on one or more predefined activities and the custom activity, and further the one or more end points may be exposed for hosting the workflow file as the integrated service.

While aspects of described system and method for generating an integrated service may be implemented in any number of different computing systems, environments, and/or configurations, the embodiments are described in the context of the following exemplary system.

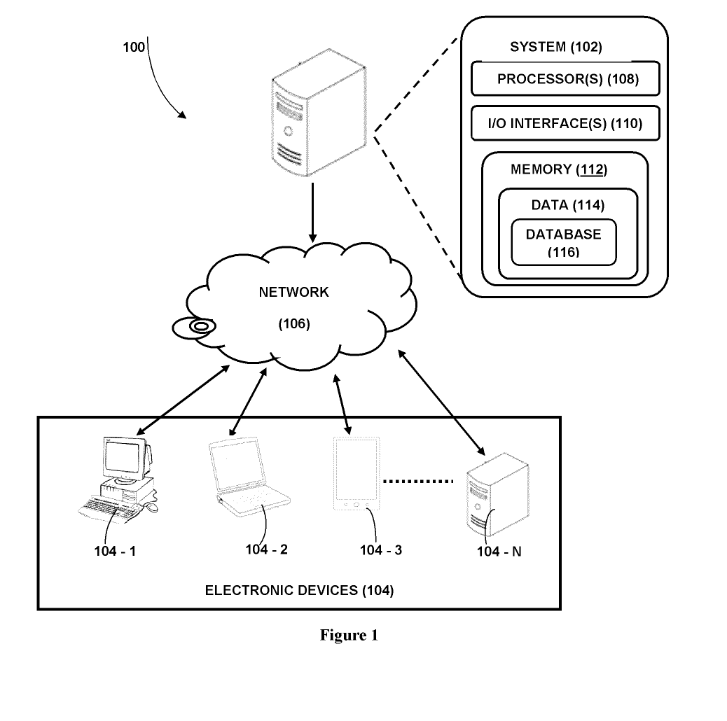

Referring now to FIG. 1, a network implementation 100 of a system 102 for generating the integrated service is illustrated, in accordance with an embodiment of the present subject matter. In one embodiment, the system 102 retrieves one or more web services from a web-service browser, based on an input received from a user. The system further extracts a web service definition of each of the one or more web services using web service description language (WSDL) files associated with the web services. Further, in one embodiment, the system 102 generates one or more proxy classes using the web service definition in the WSDL file of the web service. The system 102 further compiles the one or more proxy classes to create an assembly file. The system 102 enables the user to select a service method from the assembly file. Further, the system 102 identifies one or more endpoints for the service method. The system 102 converts the service method into a custom activity. The user may select one or more service methods. The system 102 generates a separate custom activity for each of the one or more service methods. The system generates a plurality of custom activities and displays the plurality of custom activities in user interface 110 to enable the user to select one or more custom activities. The system 102 generates a workflow file by building a workflow based on one or more predefined activities and the custom activity. The system 102 further exposes the one or more end points for hosting the workflow file as the integrated service.

Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

Referring now to FIG. 1, the system 102 is illustrated in accordance with an embodiment of the present subject matter. In one embodiment, the system 102 may include at least one processor 108, an input/output (I/O) interface 110, and a memory 112. The at least one processor 108 may be implemented as one or more microprocessors, microcomputers, microcontrollers, digital signal processors, central processing units, state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with a user directly or through the client devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 112 may include the programmed instructions and data 114.

The data 114, amongst other things, serves as a repository for storing data processed, received, and generated by execution of the programmed instructions. The data 114 may also include a system database 116.

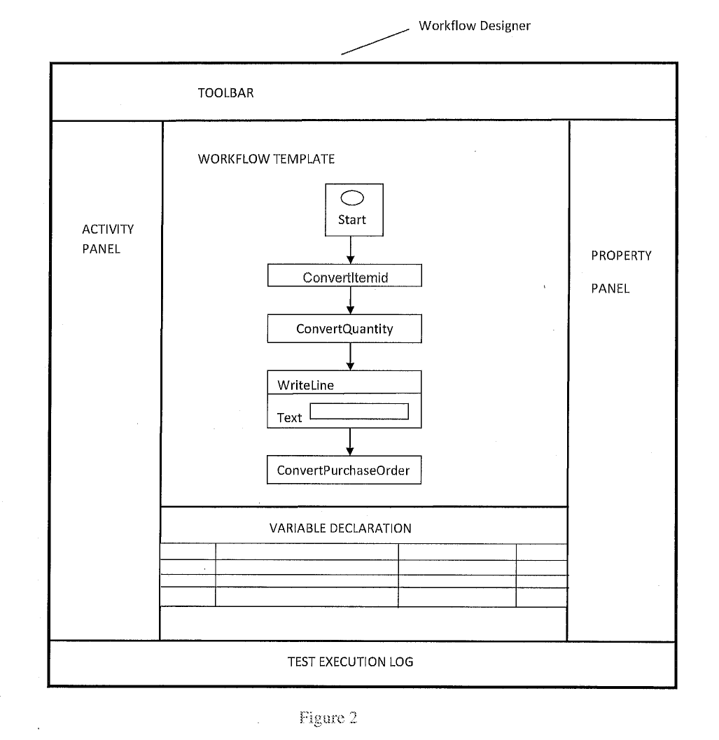

In one implementation, at first, a user may use the client device 104 to access the system 102 via the I/O interface 110. The user may register using the I/O interface 110 in order to use the system 102. The working of the system 102 may be explained in detail in FIGS. 2, 3 and 4 explained below. The system 102 may be used for generating an integrated service.

According to another embodiment of the present disclosure, generation of the integrated service is described below. In order to generate the integrated service, the system 102 may initially generate one or more custom activities. According an embodiment, generation of a custom activity is described below. In one embodiment, in order to generate the custom activity, the system 102 at first, may retrieve one or more web services from a web-service browser. The one or more web services may be retrieved based on an input received from a user. The web services may comprise Simple Object Access protocol (SOAP) based web services and Representational State Transfer (REST) based web services. In one embodiment, plurality of web services may be displayed to a user in the user interface, wherein the user may select one or more web services. In another embodiment, the user may provide web address or URL of the one or more web services in order to retrieve the one or more web services. The input for one or more web services may be set in a workflow designer or at the time of execution from a web portal.

After retrieving the one or more web services, web service description language (WSDL) file associated with each of the one or more web services may be retrieved by the system 102. The WSDL files may be retrieved using a web browser. After retrieving the WSDL files, a web service definition of the web service may be extracted using WSDL file associated with the web service by the system 102.

After extracting the web service definition of the web service, one or more proxy classes may be generated using the web service definition from the WSDL file by the system 102. While generating the one or more proxy classes, the system 102 may further add at least one of, one or more references, a namespace, and an inheritance for the one or more proxy classes. Examples of the web services are public SOAP based web service such as Currency converter, US address verification and the like. The URLs such as http://www.webservicex.net/CurrencyConvertor.asmx?WSDL and http://www.webservicex.net/ws/WSDetails.aspx?CATID-7&WSID-77 may provide further details.

After generating the one or more proxy classes, the system 102 may compile the one or more proxy classes to create an assembly file. In one example, the assembly file may be a dynamic link library (.dll) file. After generating the assembly file, system 102 may prompt the user with results discovered from the WSDL file. The system may prompt the user with service methods, functions, and parameters associated with the service methods and the functions. The user may select at least one of one or more service methods and/or one or more functions associated with the one or more service methods and/or the one or more functions. Thus the system 102 enables the user to select the one or more service methods from the assembly file. One or more parameters may be associated with a service method. The one or more parameters may get automatically selected, when the service method is selected. After selecting the one or more service methods, the system 102 may identify one or more endpoints for the one or more service methods. The one or more endpoints may be retrieved from the web service definition available in the WSDL file of the web service.

After identifying the one or more endpoints for the one or more service methods, the system 102 may convert each of the one or more service methods into a custom activity. Further, one or more parameters may be associated with a service method and the one or more parameters may get automatically selected while converting the service method into a custom activity. The one or more parameters may be used to define (pass) values at design time or at run (execution) time. The system may generate a plurality of custom activities in the same way as described above. After generating the plurality of custom activities, the system 102 may display the plurality of custom activities to the user in the I/O interface 110. The system 102 may enable the user to select the plurality of custom activities via the I/O interface 110.

According to another embodiment of the present disclosure, generation of a workflow is described. The system 102 may build a workflow based on one or more predefined activities and the custom activity. In one embodiment, in order to build the workflow, the system 102 may enable user to select one or more predefined activities. Further, the user may select the one or more predefined activities. The predefined activities may be displayed to the user in the I/O interface 110.

According to an exemplary embodiment, FIG. 2 shows a user interface of a workflow designer of the system 102, wherein the user may select various inputs required to design a workflow. The workflow designer may be enabled to design the workflow by the user, and further test the workflow. The workflow designer has three panels: an activity panel, a property panel and a test execution log panel. The activity panel may display predefined activities and custom activities. The predefined activities may be inbuilt activities as provided by selected technology. The custom activities may be generated by the system 102. To create the workflow, user may select one or more predefined activities and/or one or more custom activities from the activity panel, and place the one or more predefined activities and/or the one or more custom activities to a workflow template. The predefined activities may comprise but not limited to DoWhile, If, ForEach, Sequence, Switch, While, Flow Chart, Flow Decision, Flow Switch, Messaging and alerts. The predefined activities may comprise data type converter activities like DecimalToInt, IntToString, DecimalToDouble, DecimalToString, DoubleToDecimal, IntToDecimal, IntoToDouble, StringToDecimal, StringToDouble, BoolToString, StringToBool and StringToInt. The predefined activities may further comprise activities known to a person skilled in the art.

After defining the one or more predefined activities and the one or more custom activities, the system 102 may enable the user to define at least one of variables, data type of the variables and a scope of the variables in a variable declaration panel. The variables may store and carry values which may be used while executing the workflow. The predefined activity and the custom activity may have one or more property, and the one or more property may be used while executing the workflow as per requirement. In order to set a property for the predefined activity and/or the custom activity, the workflow designer may have a property panel. The workflow designer may have a workflow toolbar used to trigger actions like upload, test, clean and close. The system 102 may build the workflow, after defining at least one of the one or more predefined activities and/or one or more custom activities, the properties, the one or more variables, the data types of the one or more variables, scope of the one or more variables.

According to another embodiment of the present disclosure, after building the workflow, the system 102 may generate a workflow file based on the workflow. After generating the workflow file, the system 102 may execute, test, and debug the workflow file in order to validate the workflow. The system 102 may display test execution logs and errors generated in the testing and debugging of the workflow file in a test execution log panel. After validating the workflow, the system 102 may expose the one or more end points for hosting the workflow file as an integrated service. The system 102 may expose one or more bookmarks as the one or more end points.

According to another embodiment, if a workflow file already exists in the system 102, then the system 102 may update the existing workflow file to generate updated workflow file by similar method as explained in above paragraphs. Further, the system 102 may host the updated workflow file to host the integrated service.

The system may host the workflow file in an external process. Multiple workflow files may be submitted and each workflow file may be hosted in a separate process, and each workflow file may serve user's request. An endpoint for each workflow file may be exposed so that any external application or a user can access (authenticated application/user) the workflow file. After hosting the workflow file in the external process as the integrated service, the system 102 may execute the workflow file. In another embodiment, the system 102 may host a plurality of workflow files in an external process as integrated services, arrange the plurality of workflow files in a queue, and execute the plurality of workflow files by applying a job schedule.

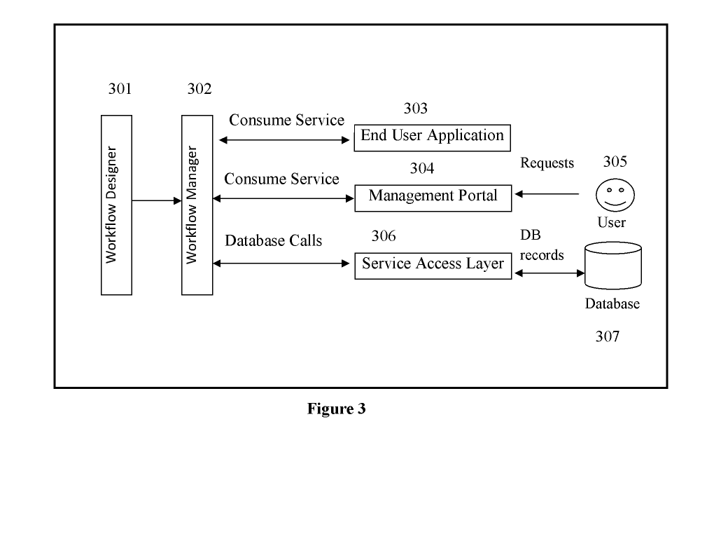

According to an exemplary embodiment, referring to FIG. 3 components of system 102 is illustrated. System 102 may have main components: a workflow designer 301, a workflow manager 302, end user application 303, a management portal 304, a service access layer 306, and a database 307. The workflow designer 301 has capabilities to test workflow and upload a workflow file to the workflow manager 302. The workflow designer 301 may create custom activities by capturing service WSDL and by generating proxy class. Workflow designer 301 may be built on top of Microsoft WF technology.

Workflow manager 302 may host integrated services and any authenticated user application 303 can interact via service end point with the management portal 304 to request execution of integrated services. The workflow manager 302 may schedule, execute and manage workflow file execution jobs. The workflow manager 302 may reschedule and terminate executing job. The workflow manager 302 may return intermediate and final execution result/logs of the workflow and custom activities and predefined activities.

Workflow manager 302 may be a multi-threaded windows service which runs in the background. Workflow manager 302 may manage the workflow execution, maintain workflow execution queue, create an endpoint by hosting the workflow file, manage rules and handles result related query operations. Whenever a user requests to execute workflow from a web portal/management portal 304, workflow manager 302 may create a queue and may schedule a job execution request. Workflow manager 302 may return execution status, may update task's status to the database, and then may periodically check in the database whether all the tasks are completed or not. On completion of all the tasks, Workflow manager 302 may return the final status of the job. The management portal 304 may be a web based platform to schedule and manage workflow execution. The management portal 304 may also facilitate to input required parameters at time of execution. If a user requests to execute workflow then the management portal 304 may submit request to the workflow manager 302, and may periodically check for status and execution logs. The management portal 304 may submit a job with required input parameters to the workflow manager 302. The management portal 304 may manage user, workflow execution and maintaining execution logs. The management portal 304 may access bookmarks mentioned in the workflow file and resume the bookmark with required input/actions. Bookmark comprises points where system 102 processing may be paused and system 102 may wait for further instruction to resume the execution. A simple example of bookmark may be a system 102 is waiting for ‘Approval’ or ‘Rejection’ of a purchase order. The system 102 may also include a search and a reporting module which may empower the user with the workflow execution traceability.

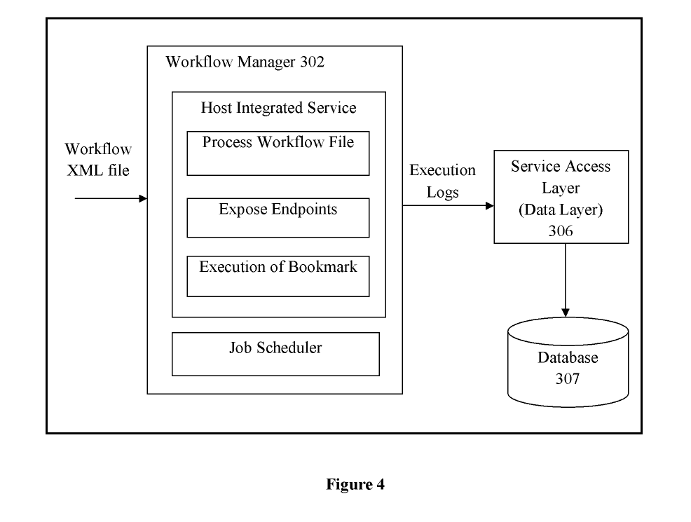

According to an exemplary embodiment, referring to FIG. 4, a flowchart illustrates steps and a flow of execution of the integrated service. The system 102 may comprise workflow manager 302 for executing the integrated service. FIG. 4 shows process flow diagram of the workflow manager 302, illustrating a request queue, a workflow execution and a service endpoint. At first user may design workflow in the workflow designer 301 and a workflow file may be generated by the workflow designer 301 using the workflow. In one example, the workflow file may be in a xml format. The workflow file may be uploaded by the workflow manager 302. Workflow manager 302 may validate and execute the workflow file. By identifying host able methods, workflow manager 302 may host integrated service for the workflow and may expose end points for the service methods. When the user submits workflow execution request, a job scheduler of the workflow manager, may add the workflow execution request in a queue. The job scheduler may launch a job for the workflow execution in a separate thread by picking the workflow execution request from the queue. The workflow manager 302 further may execute bookmark as mentioned in the workflow file while hosting the integrated service. Further workflow manager 302 may generate execution logs/status while hosting the integrated service and may update the execution logs/status into a service access layer (data layer) 306. The execution logs/status from the service access layer (data layer) 306 may further saved into a database 307.

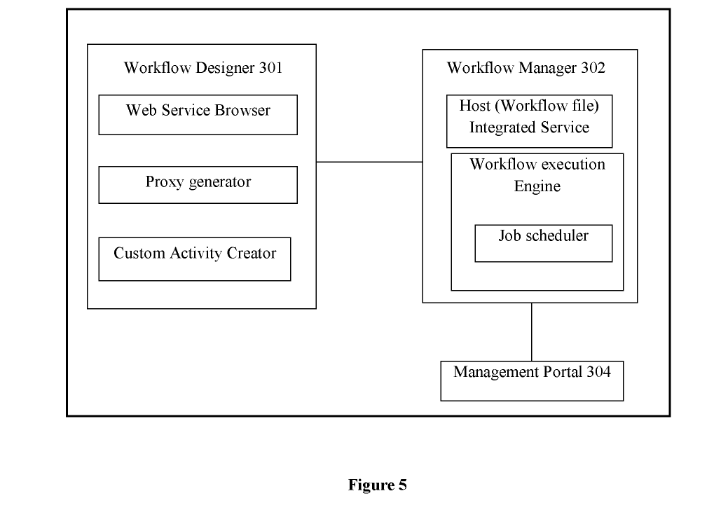

Referring to FIG. 5, overall working of system 102 to generate an integrated service is explained below. FIG. 5 shows system 102 components overview. Using a workflow designer 301 of the system 102, user may provide URL to a web service browser to discover and load web service definitions from WSDL file. Proxy generator of workflow designer 301 may generate proxy classes by using the web service definition from the WSDL file and then may compile the proxy classes to create an assembly (All) file. The workflow designer 301 may prompt discovery result and list of service methods retrieved while generating the assembly file to the user. The user may select required service methods, and then the workflow designer 301 may create custom activities using custom activity creator for the selected service methods and add the custom activities to a workflow portal/panel. Further, the user may design a workflow using one or more predefined activities and one or more custom activities in a workflow panel/portal. The workflow designer 301 may further generate a workflow file using the workflow. User may further upload the workflow file to a workflow manager 302. Further, the workflow manager 302 may validate and may process the workflow file to host an integrated service, and may expose end points for the workflow. Workflow execution engine may comprise a job scheduler. User may put a request to execute the integrated service. The job scheduler may add the request to a queue and schedule request and accordingly execute the workflow file to execute the integrated service.

The system 102 may be Software as a Service (SaaS) based solution having combination of workflow designer 301, workflow manager 302 and management portal 304. The system 102 may enable design, execution, bookmarking, debugging and testing the workflow. The system 102 may be highly customizable with a generic rule engine. In one example, the system 102 is based on Microsoft™ WF™ technology and has capabilities to design a complex workflow. The system 102 may be supported with real-time reporting of current state of the system. The system 102 may also be hosted in a cloud.

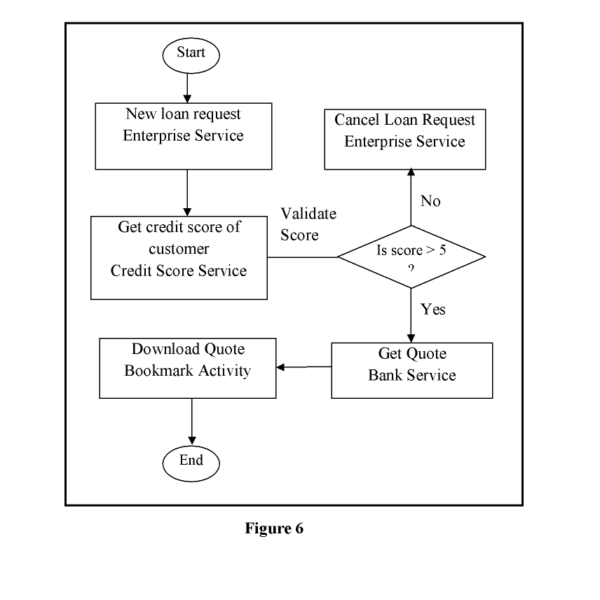

According to an exemplary embodiment, an example of generation of an integrated service for a loan request processing is explained. In order to generate the integrated service for loan request processing. For example, when a loan broker make request on behalf of a customer to bank, the loan broker uses three web services such as 1) a web service to make initial loan request in enterprise service, 2) a web service to obtain credit score from credit agency, and 3) a web service to get a quote from a bank. Hence to create the integrated service for loan request processing, these three web services needs to be combined in a work flow in a customized way. Referring to FIG. 6, a workflow for generating the integrated service for loan request processing is explained below.

In order to generate the integrated service for loan request processing, a user first selects three SOAP based web services such as 1) Loan Request Enterprise Service 2) Credit Score Service 3) Bank Service to Get Quote. User may select these web services by putting name/web address/URL for the web services in web browser. The system 102 retrieves the web services from a web-service browser, based on an input received from the user. The system 102 further extracts a web service definition of the three web services using web service description language (WSDL) files associated with the three web services. The system 102 further generates proxy classes using the web service definitions and compiles the one or more proxy classes to create an assembly file. The system 102 enables the user to select service methods and parameters from the assembly file.

In the present example, user selects service methods such as NewLoanRequest(customerdetails), CancelLoanRequest(requestId) from Loan Request Enterprise Service, GetCreditScore(customerdetails) from Credit Score Service and GetQuote(customerdetails,creditscore) from Bank Service to get a quote. The system 102 identifies one or more endpoints for the service methods using the web service definition. Further system 102 converts the service methods into one or more custom activities. The selected service methods with the parameters are converted into custom activities and added as custom activities to the activity panel of the system 102, wherein the user selects these custom activities while generating a workflow.

Referring to FIG. 6, the workflow for generating the integrated service for loan request processing is illustrated. The workflow shows that user has added service methods such as NewLoanRequest, GetCreditScore, CancelLoanRequest and GetQuote as Custom activities, ValidateScore as Standard decision making activity selected from predefined activities, and DownloadQuote as a Boomark activity. Bookmark activity shows that user can manually download a quote and system may wait for user's further instruction to proceed (or end the task.) Further, the system 102 uses parameters such as LoanId (Stores loan id generated from NewLoanRequest used to cancel or complete loan request) and ScoreVariable (Stores score received from Credit Score Service is used to take further processing decision).

User adds (drags and drops) and arranges the custom activities and predefined activities as shown in the FIG. 6. The workflow gets executed as shown in a flow diagram in the FIG. 6. The system 102 generates a workflow file by building the workflow based on the predefined activities and the custom activities as selected by the user. The system 102 further exposes end points for hosting the workflow file as the integrated service for loan request processing.

The exemplary embodiments discussed above may provide certain advantages. Though not required to practice aspects of the disclosure, these advantages may include those provided by the following features.

Some embodiments enable a system and a method for generating and hosting an integrated service by defining a workflow, executing the integrated service as per defined workflow and host end points of the integrated service. The integrated service may be a web based service.

Some embodiments enable the system and the method for generating custom activities by using one or more service methods of one or more web services.

Some embodiments enable the system and the method for generating a workflow by using custom activities and predefined activities.

Some embodiments enable the system and the method for testing, debugging and validating the workflow.

Some embodiments enable the system and the method for generating and hosting customized integrated service which is reusable, less time consuming and simple in execution.

Some embodiments enable the system and the method for generating and hosting the integrated service, wherein generated workflows are reusable and updatable as per user requirement.

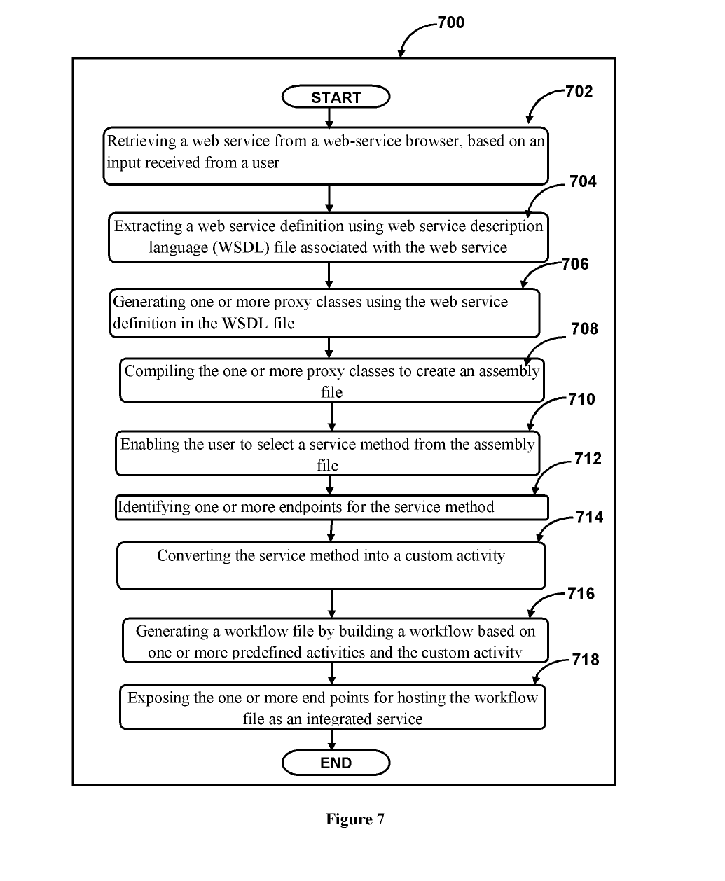

Referring now to FIG. 7, a method 700 for generating an integrated service is shown, in accordance with an embodiment of the present subject matter. The method 700 may be described in the general context of computer executable instructions. Generally, computer executable instructions can include routines, programs, objects, components, data structures, procedures, modules, functions, etc., that perform particular functions or implement particular abstract data types. The method 700 may also be practiced in a distributed computing environment where functions are performed by remote processing devices that are linked through a communications network. In a distributed computing environment, computer executable instructions may be located in both local and remote computer storage media, including memory storage devices.

The order in which the method 700 is described is not intended to be construed as a limitation, and any number of the described method blocks can be combined in any order to implement the method 700 or alternate methods. Additionally, individual blocks may be deleted from the method 700 without departing from the spirit and scope of the subject matter described herein. Furthermore, the method can be implemented in any suitable hardware, software, firmware, or combination thereof. However, for ease of explanation, in the embodiments described below, the method 700 may be considered to be implemented in the above described system 102.

At block 702, one or more web services from a web-service browser may be retrieved, based on an input received from a user. The input may be an URL for each of the one or more web services. In one implementation, the one or more web services from the web-service browser may be retrieved by the system 102 using the URL.

At block 704, a web service definition of the web service may be extracted using a web service description language (WSDL) file associated with the web service. In one implementation, the web service definition of the web service may be extracted by the system 102.

At block 706, one or more proxy classes may be generated using the web service definition in the WSDL file. In one implementation, the one or more proxy classes may be generated by the system 102.

At block 708, the one or more proxy classes may be compiled to create an assembly file. In one implementation, the one or more proxy classes may be compiled by the system 102.

At block 710, the user may be enabled to select a service method from the assembly file. In one implementation, the user may be enabled to select a service method by the system 102.

At block 712, one or more endpoints for the service method may be identified using the web service definition. In one implementation, one or more endpoints for the service method may be identified by the system 102.

At block 714, the service method may be converted into a custom activity. In one implementation, the service method may be converted into a custom activity by the system 102. One or more parameters may be associated with the service method. The one or more parameters may get automatically selected while converting the service method into the custom activity.

At block 716, a workflow file may be generated by building a workflow based on one or more predefined activities and the custom activity. In one implementation, a workflow file may be generated by the system 102.

At block 718, the one or more end points may be exposed for hosting the workflow file as an integrated service. In one implementation, the one or more end points may be exposed for hosting the workflow file as the integrated service by the system 102.

In method 700, generating the one or more proxy classes further comprises adding one or more references, a namespace, and an inheritance for the one or more proxy classes. In method 700, building the workflow further comprises defining one or more properties, one or more variables, data type of the one or more variables, and scope of the one or more variables. The method 700 further comprises executing, testing, and debugging the workflow file in order to validate the workflow. The method 700 further comprises exposing one or more bookmarks as the one or more end points. The method 700 further comprises converting a plurality of service methods into a plurality of custom activities. The method 700 further comprises hosting a plurality of workflow files in an external process as integrated services, and arranging the plurality of workflow files in a queue and executing the plurality of workflow files by applying a job schedule.

Although implementations for methods and systems for generating an integrated service have been described in language specific to structural features and/or methods, it is to be understood that the appended claims are not necessarily limited to the specific features or methods described. Rather, the specific features and methods are disclosed as examples of implementations for generating the integrated service.

What is claimed is:

1. A method for generating an integrated service, the method comprising:
retrieving, by a processor, a web service from a web-service browser, based on an input received from a user;
extracting, by the processor, a web service definition of the web service using a web service description language (WSDL) file associated with the web service;
generating, by the processor, one or more proxy classes using the web service definition in the WSDL file;
compiling, by the processor, the one or more proxy classes to create an assembly file;
enabling, by the processor, the user to select a service method from the assembly file;
identifying, by the processor, one or more endpoints for the service method using the web service definition;
converting, by the processor, the service method into a custom activity;
generating, by a processor, a workflow file by building a workflow based on one or more predefined activities and the custom activity; and
exposing, by the processor, the one or more end points for hosting the workflow file as an integrated service.

2. The method of claim 1, wherein generating the one or more proxy classes further comprises adding one or more references, a namespace, and an inheritance for the one or more proxy classes.

3. The method of claim 1, wherein building the workflow further comprises defining one or more properties, one or more variables, data type of the one or more variables, and scope of the one or more variables.

4. The method of claim 1 further comprises executing, testing, and debugging the workflow file in order to validate the workflow.

5. The method of claim 1 further comprises exposing one or more bookmarks as the one or more end points.

6. The method of claim 1 further comprises converting a plurality of service methods into a plurality of custom activities.

7. The method of claim 1 further comprises hosting a plurality of workflow files in an external process as integrated services, and arranging the plurality of workflow files in a queue and executing the plurality of workflow files by applying a job schedule.

8. A system for generating an integrated service, the system comprising:
a processor; and
a memory coupled to the processor, wherein the processor is capable of executing programmed instructions stored in the memory to:
retrieve a web service from a web-service browser based on an input received from a user;
extract a web service definition of the web service using a web service description language (WSDL) file associated with the web service;
generate one or more proxy classes using the web service definition in the WSDL file;
compile the one or more proxy classes to create an assembly file;
enable the user to select a service method from the assembly file;
identify one or more endpoints for the service method;
convert the service method into a custom activity;
generate a workflow file by building a workflow based on one or more predefined activities and the custom activity; and
expose the one or more end points for hosting the workflow file as an integrated service.

9. The system of claim 8 further comprises programmed instructions to execute, test, and debug the workflow file in order to validate the workflow.

10. The system of claim 8 further comprises programmed instructions to expose one or more bookmarks as the one or more end points.

11. A computer program product having embodied thereon a computer program for generating an integrated service, the computer program product comprising:
a program code for retrieving a web service from a web-service browser based on an input received from a user;
a program code for extracting a web service definition using a web service description language (WSDL) file associated with the web service;
a program code for generating one or more proxy classes using the web service definition in the WSDL file;
a program code for compiling the one or more proxy classes to create an assembly file;
a program code for enabling the user to select a service method from the assembly file;
a program code for identifying one or more endpoints for the service method;
a program code for converting the service method into a custom activity;
a program code for generating a workflow file by building a workflow based on one or more predefined activities and the custom activity; and
a program code for exposing the one or more end points for hosting the workflow file as an integrated service.
